(19) United States
(12) Patent Application Publication
(10) Pub. No.: US 2011/0134205 A1
(43) Pub. Date: Jun. 9, 2011

(54) IMAGING TERMINAL

(76) Inventors: Susanne Arney, Highland Park, NJ (US); Cristian A. Bolle, Bridgewater, NJ (US); Gang Chen, Bridgewater, NJ (US); Roland Ryf, Aberdeen, NJ (US)

(21) Appl. No.: 12/633,429

(22) Filed: Dec. 8, 2009

(51) Int. Cl. H04N 7/15; H04N 5/222

(52) U.S. Cl. 348/14.08; 348/333.1; 348/E05.022; 348/E07.083

(57) ABSTRACT

An apparatus includes a state-switchable screen, a video camera, and a video projector. The video camera and projector are located on a side of the screen opposite to the side thereof of a video conference participant. The apparatus is configured to temporally interleave the screen between a substantially transparent state and a diffusive state. In the substantially transparent state, the video projector is configured to be outside of a viewing field of a video conference participant looking toward the video camera.

This application claims the benefit of U.S. provisional patent application No. 6______ titled “IMAGING TERMINAL”, which was filed on Dec. 7, 2009 by Susanne Amey, Cristian A. Bolle, Gang Chen, and Roland Ryf.

### BACKGROUND

1. Field of the Invention

The invention relates to apparatus and methods for use in projection imaging or videoconferencing.

2. Discussion of the Related Art

This section introduces aspects that may be helpful to facilitating a better understanding of the inventions. Accordingly, the statements of this section are to be read in this light and are not to be understood as admissions about what is in the prior art or what is not in the prior art.

Videoconferencing has become popular as a communication technique for face-to-face meetings in which participants are physically remote to each other. In a videoconference, a local videoconference participant uses a videoconferencing terminal that typically includes a video camera, a display screen, a microphone and an audio speaker. The camera and microphone capture the visual and audio input for the video stream to be transmitted to the remote videoconference participant, and the display screen and audio speaker display the visual and audio portions of the video stream received from the remote videoconference participant.

For some videoconferencing terminals, a local videoconference participant may be provoked to look to one side of the video camera for various reasons. One such reason may be that the video camera is located on top of the display screen so that a local videoconference participant, who is watching the display screen, will be looking downward rather than looking directly into the video camera. If the local videoconference participant is looking downward rather than looking directly into the video camera, the video image will show the local videoconference participant as looking downward rather than as looking into the eyes of the remote videoconference participant. For that reason, such a videoconferencing terminal will often cause a remote videoconference participant to perceive the local videoconference participant as not maintaining eye contact even when the local videoconference participant is actually looking directly at the remote videoconference participant on his or her local display screen.

### BRIEF SUMMARY

One embodiment features an apparatus that includes a state-switchable screen and a video camera and a video projector. The video camera and projector are located on a side of the screen opposite to the side thereof of a video conference participant. The apparatus is configured to temporally interleave the screen between a substantially transparent state and a diffusive state. In the substantially transparent state, the video projector is configured to be outside of a viewing field of a video conference participant looking toward the video camera.

Another embodiment features a method for operating a video conferencing terminal that includes a state-switchable screen, a video camera, and a video projector. The video camera and projector are located on a side of the screen opposite to the side thereof of a video conference participant. The method includes temporally interleaving the screen between a diffusive state and a substantially transparent state. In a frame of the substantially transparent state, the video camera captures an image frame. In a frame of the diffusive state, the video projector projects a frame of a video image on the screen. The terminal is configured such that the video projector is outside of a viewing field of a person, in the transparent state if the person is directly looking at the video camera.

Another embodiment features a method for operating a video conferencing terminal. The video conferencing apparatus includes a state-switchable screen, a video camera, and a video projector. The video camera and projector are located on a side of the screen opposite to the side thereof of a video conference viewer. The method includes temporally interleaving the screen between a diffusive state and a substantially transparent state. In a frame of the substantially transparent state, the video camera captures an image frame. In a frame of the diffusive state, the video projector displays the captured image frame on the screen such that the viewer is able to make eye-contact with himself or herself by looking directly at the video camera.

### BRIEF DESCRIPTION OF THE DRAWINGS

FIG. 1 is a cross-sectional view schematically illustrating a visual portion of one embodiment of a videoconferencing terminal;

FIG. 2 schematically illustrates a single video image transmitted to a remote videoconferencing terminal by the videoconferencing terminal in FIG. 1, i.e., a frame illustrating direct eye-contact;

Views A-C of FIG. 3 are timing diagrams illustrating different modes of operating a videoconferencing terminal illustrated in FIG. 1;

FIG. 4 is a cross-sectional view of a liquid crystal-based embodiment of a state-switchable screen as illustrated in FIG. 1;

FIG. 5 is a cross-sectional view illustrating various specific embodiments of the videoconferencing terminal as illustrated in FIG. 1;

FIG. 6 is a flow chart illustrating a method of operating a videoconferencing terminal, e.g., the videoconferencing terminals illustrated in FIGS. 1 and 5;

FIG. 7 is a flow chart illustrating a method of operating an imaging terminal in a pseudo-mirror mode, e.g., for use with the videoconferencing terminals illustrated in FIGS. 1 and 5; and

FIG. 8 schematically illustrates a single image of the pseudo-mirror mode, which was made according to the method illustrated in FIG. 7.

In the Figures and text, like reference numerals indicate elements with similar functions and/or similar structures.

In the Figures, the relative dimensions of some features may be exaggerated to more clearly illustrate one or more of the structures therein.

In various Figures, dashed lines with arrows thereon schematically indicate light rays.

Herein, various embodiments are described more fully by the Figures and the Detailed Description of Illustrative Embodiments. Nevertheless, the inventions may be embodied in various forms and are not limited to the embodiments described in the Figures and in the Detailed Description of Illustrative Embodiments.

### DETAILED DESCRIPTION OF ILLUSTRATIVE EMBODIMENTS

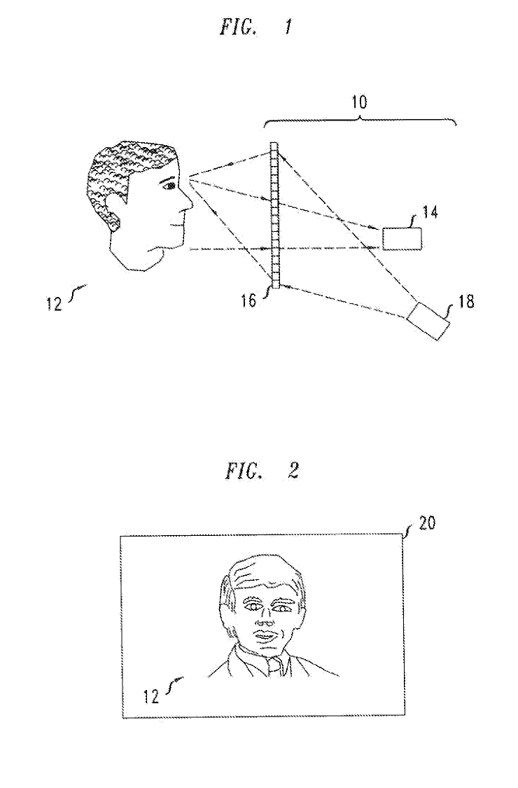

FIG. 1 illustrates a videoconferencing terminal 10 that is operated by a local videoconference participant 12. The videoconferencing terminal 10 has a visual portion that includes, at least, a video camera 14, a state-switchable screen 16, and a video projector 18. The videoconferencing terminal 10 also has an audio portion that typically includes one or more audio speakers and one or more audio microphones (not shown).

In the visual portion of the videoconferencing terminal 10, the video camera 14 is located and oriented to capture video images with light transmitted through the state-switchable screen 16, and the video projector 18 is oriented to project video images onto the state-switchable screen 16. The video projector 18 and the video camera 14 are both located on the same backside of the state-switchable screen 16. The local videoconference participant 12 views the front side of the state-switchable screen. That is, the local videoconference participant 12 and the video camera 14 and projector 18 are located on opposite sides of the state-switchable screen 16.

In the audio portion of the videoconferencing terminal 10, the one or more audio speakers output(s) the audio part of the videoconference, which is captured by the videoconferencing terminal of the remote videoconference participant, and the one or more audio microphones capture(s) the audio part of the videoconference at the local videoconferencing terminal 10.

The videoconferencing terminal 10 transmits a data stream for video images captured by the video camera 14 and audio input captured by the local microphone(s) to a videoconferencing terminal of a remotely located videoconference participant (both not shown). The videoconferencing terminal 10 substantially simultaneously receives a data stream for the video images and audio input captured by the videoconferencing terminal of the remote videoconference participant. The videoconferencing terminal of the remote videoconference participant may be similar to the local videoconferencing terminal 10 or may be a different type of videoconferencing terminal, e.g., a conventional video conferencing terminal. The data streams are transmitted between the remote and local videoconferencing terminals via a data network (not shown) to support the videoconferencing session between the local participant 12 and the remote participant.

In some embodiments of the videoconferencing terminal 10, the one or more audio microphones, e.g., directional microphone(s), provide the videoconferencing terminal 10 with data to track the direction and/or position of the head of the local videoconference participant 12, who is presently talking. In these embodiments, such tracking information may be used to re-orient and/or rotate the video camera 14 so that the video camera 14 remains directed at the presently talking, videoconference participant 12. That is, the track enables compensation for movements of the head of the talking person and/or for changes of the local videoconference participant 12, who is talking. Such tracking may better enable the local videoconferencing terminal to to produce video images that continue to provide a perception of eye-contact.

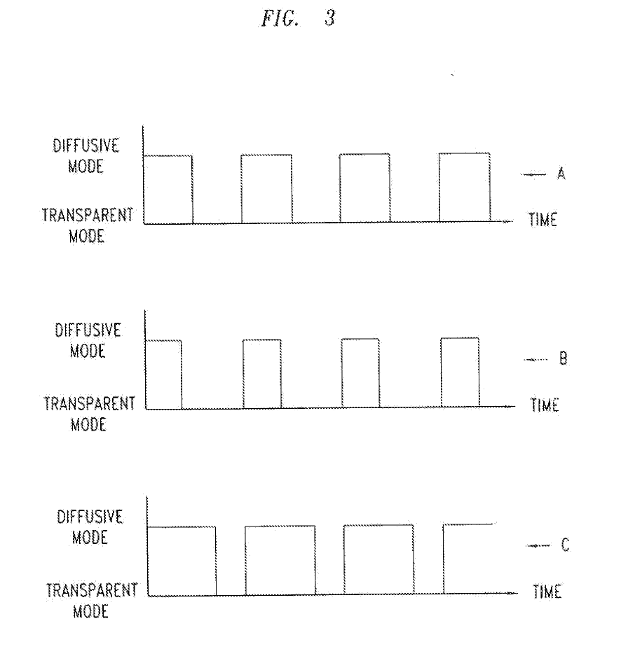

FIG. 2 illustrates a video image that the local videoconferencing terminal 10 illustrated in FIG. 1 might transmit to a videoconferencing terminal 20 of a remote videoconference participant. From the video image, the remote videoconference participant would typically perceive the local videoconference participant 12 as maintaining eye-contact with him or her, because the local videoconference participant 12 was looking directly at the video camera 14 of his or her videoconferencing terminal 10 when the video image was captured.

Such a perceived direct eye-contact results, because the local videoconference participant 12 looks directly into his/her local video camera 14 when looking directly at the remote videoconference participant on his or her own local video conferencing terminal 10. That is, the local video camera 14 is located and oriented so that the local videoconference participant 12 looks directly therein when looking at the remote videoconference participant in the local video image.

Referring again to FIG. 1, the state-switchable screen 16 has both a light diffusive state and a substantially transparent state.

When the state-switchable screen 16 is in the light diffusive state, the video projector 18 projects the video images received from the remote video terminal 20 onto the state-switchable screen 16. Thus, in the light diffusive state, the state-switchable screen 16 diffuses incident light, e.g., similar to an ordinary projection screen, so that the local videoconference participant 12 can see a projected image from the opposite side of the state-switchable screen 15.

In various embodiments, the images received from the remote video terminal 20 are part of full images projected onto the backside of the state-switchable screen 16 by the video projector 18 during the diffusive state. The full projected images may simply be the images captured at the remote videoconferencing terminal 20 or may include additional portions such as a computer graphical user interface (e.g., with the Microsoft Windows GUI). In the later case, the images received from the remote video terminal 20 may be contained within one window of such a projected computer graphical user interface.

When the state-switchable screen 16 is in the substantially transparent state, the video camera 14 captures image frame(s) of the local videoconference participant 12 and surrounding scene through the state-switchable screen 16. In the substantially transparent state, the state-switchable screen 16 may be transparent to visible light or may filter out a portion of the visual light spectrum. In the substantially transparent state, the state-switchable screen 16 may even cause attenuation of incident visible light, e.g., a 10-20% intensity attenuation. But, the substantially transparent state typically allows the formation of clear images from the light transmitted through the state-switchable screen 16. Thus, in the substantially transparent state, the state-switchable screen 16 passes light emitted by the local videoconference participant 12 and surrounding scene so that the video camera 14 is able to form clear image frame(s) of the local videoconference participant 12 and surrounding scene.

To improve quality of the time-averaged video image, the video projector 18 is located outside of the field-of-view of the local videoconference participant 12 when looking directly towards the video camera 16. Thus, even in the substantially transparent state, the videoconference participant 12 will not ordinarily see the video projector 18 or an image of the video projector 18. For that reason, the time-averaged video image, which is produced by temporal interleaving and is effectively observed by the videoconference participant 12, will not have a significant phantom image of a part of the video projector 18.

To support videoconferencing, the controllable screen 16 is rapidly temporally interleaved between the diffusive state and the substantially transparent state. For example, the temporal interleaving rate may be 30 Hertz or higher and preferably is about at 120 Hertz or higher.

Referring to FIG. 3, views A-C schematically illustrate different methods for temporal interleaving the state-switchable screen 16 of FIG. 1 between the diffusive and substantially transparent states. View A illustrates an interleaving method for which the state-switchable screen 16 is in each state for about equal percentages of each operating cycle, e.g., from 45%-55% of each operating cycle. View B illustrates an interleaving method for which the state-switchable screen 16 is in the substantially transparent state for a larger percentage of each operating cycle, e.g., greater than 60% of each operating cycle or even greater than 70% of each operating cycle. This method may be used, e.g., when the video camera 14 has low sensitivity to provide a larger percentage of each operating cycle for capturing the light needed to produce quality video images. View C illustrates an interleaving method for which the state-switchable screen 16 is in the diffusive state for a larger percentage of each operating cycle, e.g., greater than 60% of each operating cycle or even greater than 70% of each operating cycle. This method may be used when the video camera 14 has a high sensitivity to provide a larger percentage of each operating cycle for projecting brighter or higher contrast video images to the local videoconference participant 12.

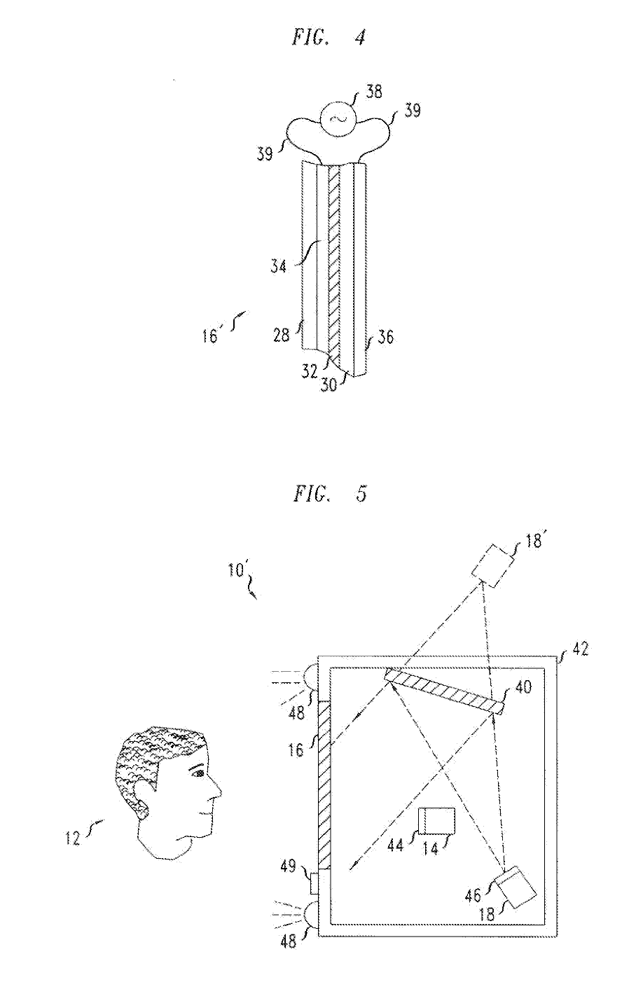

FIG. 4 illustrates a specific embodiment 16′ of state-switchable screen 16 of FIG. 1. The screen 16′ includes a transparent user-protection substrate 28, a transparent planar substrate 30, a state-switchable coating 32, two transparent electrode layers 34, 36, an AC voltage source 38, and conducting leads 39. The transparent substrates 28, 30 may be, e.g., transparent and electrically insulating clear glass plates. The state-switchable layer 32 may be a liquid crystal layer, e.g., a polymer stabilized cholesteric liquid crystal layer. The transparent electrode layers 34, 36 may be, e.g., indium tin oxide layers. The AC voltage source 38 provides a large enough peak AC voltage across the transparent electrode layers 34, 36 to enable switching of the state-switchable coating 32 between the diffusive state and the substantially transparent state.

An example state-switchable screen 16′ may be purchased as a light shutter from LC-TEC of Sweden (www.lc-tec.se). For example, the LC-TEC model FOS-307×406-PSCT diffuser may be used to produce a rectangular embodiment of the state-switchable screen 16′ that has edge lengths of about 307 mm and of about 406 mm This embodiment of the state-switchable screen 16′ is diffusive at zero applied voltage and substantially transparent at about 150 applied volts. This embodiment of the state-switchable screen 16′ can be switched with an operating cycle frequency of 60 Hertz or more, 120 Hertz or more, or even about 180 Hertz.

FIG. 5 illustrates an embodiment 10′ of the videoconferencing terminal 10 that shows features that may be optionally included in some specific embodiments of the videoconferencing terminal 10 illustrated in FIG. 1.

The videoconferencing terminal 10′ may include one or more reflectors 40 for specularly reflecting light from the video projector 18 to the state-switchable screen 16. The one more reflectors 40 can provide a folded optical arrangement that enables the visual portion of the videoconferencing terminal 10′ to have a thinner footprint. The footprint may be further reduced by using off-axis optics and/or folded optics for the video projector 18 and/or the video camera 14. Such footprint reduction may also involve pre-distorting the image beam from the video projector 18 to pre-compensate for keystone image distortion that is caused by an off-axis and/or folded optical beam delivery system for the video projector 18.

The one or more reflectors 40 are typically oriented to redirect light from the video projector 18 such that the light is incident on the state-switchable screen 16 at an oblique incidence angle. Due to the oblique incidence angle a virtual image 18′ of the video projector 18 will typically be located outside of the field-of-view of the videoconference participant 12, e.g., as long as the videoconference participant 12 looks directly towards the video camera 14. For that reason, the virtual image 18′ will not be an optical defect on the time-averaged video images perceived by the videoconference participant 12.

The videoconferencing terminal 10′ may include a light-tight box 42 surrounding the video camera 14, the video projector 18, and the one or more reflectors 40. The light-tight box 42 has a blackened inner surface. The video camera 14 and video projector 18 also have blackened outer surfaces, e.g., except the optical input and output ports thereon. Such blackened surfaces reduce the reflection and scattering of stray light so that the light-tight box 42 does not output light via the state-switchable screen 16 in the substantially transparent state. Such an output of stray light could otherwise contaminate the time-averaged visual images perceived by the local videoconference participant 12 with undesirable phantom features.

The video camera 14 and video projector 18 may include aperture shutters 44, 46 configured to be operated at the operating frequency of the state-switchable screen 16 and to be coordinated with the operation of the state-switchable screen 16. The shutter 44 is operated to cause the video camera 14 to not collect light for video images when the state-switchable screen is in the diffusive state. This shuttering reduces contributions of light backscattered off the state-switchable screen 16 to the video images produced by the video camera 14 thereby reducing occurrences of and/or the intensity of phantom image features therein. The shutter 46 is operated to cause the video projector 18 to not output stray light when the state-switchable screen is in the substantially transparent state. This shuttering reduces the effect of stray light from the video projector 18 on the video images that are perceived by the videoconference participant 12. That is, eliminating stray light while the state-switchable screen 16 is in the substantially transparent state reduces contributions of stray light to the time-averaged images that are perceived by the videoconference participant 12

Rather than physical shutters 44, 46, some alternate embodiments may implement internal electronic shuttering of the video camera 14 and/or the video projector 18. For example, the video camera 14 may include a CCD light detector that is operated to not accumulate light generated charge when the state-switchable screen 16 is in the diffusive state. In another example, the shuttering of the video projector 18 can be achieved by switching on and off the illumination light sources inside the projector 18, i.e., as appropriate to implement shuttering of stray light.

The terminal 10′ may also include one or more external light(s) 48 that frontally illuminate the face of the videoconference participant 12. Such front illumination can improve the quality of the video images produced by the video camera 14.

The terminal 10′ may also include one or more sensors 49 for gathering data for the videoconferencing terminal 10′ to use in determining the position, direction, and/or eye-gaze direction of the videoconference participant 12. The sensors 49 may include one or more microphones, e.g., a directional microphone, that provide voice data to track the direction of the local videoconference participant 12 that is presently talking. The sensors 49 may include one or more infrared detectors that detect either the head or the eye-gaze direction of the videoconference participant 12. For example, the videoconferencing terminal 10′ may include software for processing received images from said infrared detectors to determine the location of the “colder” nose, cooler glasses and/or hotter eyes of the videoconference participant 12. The videoconferencing terminal 10′ could then, process said data to locate the head or eye-gaze of the videoconference participant 12.

In the above-described embodiments, the tracking positional and/or directional data on the videoconference participant 12 may be used to automatically move or re-orient the video camera 14. Such moving or re-orienting of the video camera 14 could help to ensure that the videoconference participant 12 or the talking videoconference participant 12 of a local group of participants continues to look directly at the video camera 14.

In alternate embodiments, the videoconferencing terminal 10′ may include a 1D or 2D array of video cameras 14 rather than a single movable or re-oriental video camera 14. Then, the tracking of the local videoconference participant 12 to maintain eye-contact, as described above, may involve dynamically selecting for the capture of video images that one of the video cameras 14 of the array into which the relevant videoconference participant 12 is presently looking.

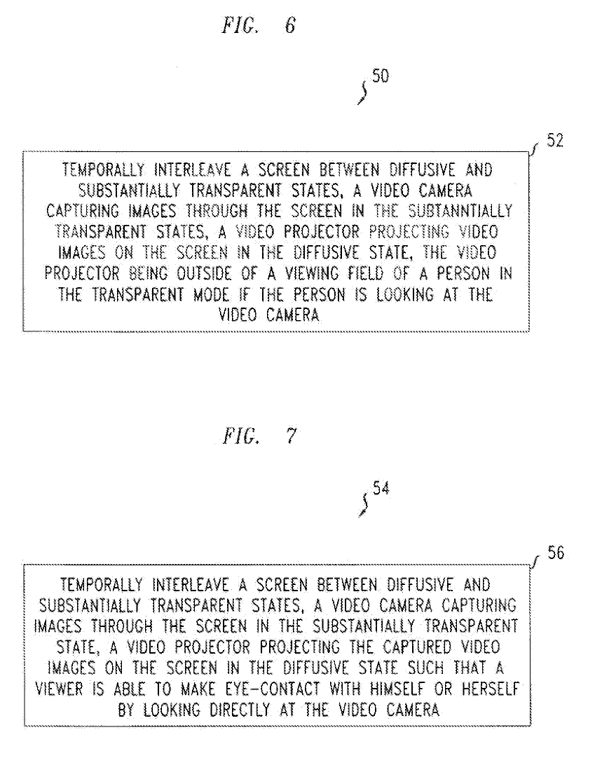

FIG. 6 illustrates one method 50 of operating a videoconferencing terminal, e.g., videoconferencing terminals 10, 10′ of FIGS. 1 and 5. The videoconferencing terminal is configured such that a video projector thereof, e.g., the video projector 18, and any virtual or actual image thereof is outside of the field-of-view of the local videoconference participant, e.g., the videoconference participant 12, while said participant is directly looking at the video camera.

The method 50 includes causing a state-switchable screen, e.g., the screen 16, to be temporally interleaved between a diffusive state and a substantially transparent state (step 52). The interleaving may involve regularly switching the state of the state-switchable screen between the diffusive and substantially transparent states. During the interleaving, the length of time in each of the two states may be about the same or significantly different.

When the screen is in the diffusive state, the video projector projects video image(s) on the screen. The projected video images are viewable by the local videoconferencing participant located on the other side of the state-switchable screen. The method 50 may be such that the video projector does not project light when the screen is in the substantially transparent state, e.g., due to synchronized projector shuttering.

When the screen is in the substantially transparent state, a video camera, e.g., the video camera 14, captures clear video image(s) of the scene surrounding the local videoconference participant through the state-switchable screen. The method 50 may be such that the video camera does not capture light for video images when the screen is in the diffusive state, e.g., due to synchronized camera shuttering.

The method 50 may be such that the video camera is configured to translate or re-orient such that a local talking videoconferencing participant still looks directly into the video camera when the head of said participant translates, the eye gaze of said participant changes, or the identity of the talking one of the local participant of a group changes. For example, the terminal may use eye gaze, head, and/or audio tracking to relocate or re-orient the video camera.

The method 50 may further include deflecting light of video images from the video projector to the state-switchable screen via a mirror, e.g., the reflector 40. In such embodiments, the minor is located such that any virtual image of the video projector is located outside of a field-of-view of the videoconferencing participant while looking towards the video camera. Such virtual images could otherwise be viewable when the state-switchable screen is in the substantially transparent state.

FIG. 7 is a flow chart illustrating a method 54 of operating an imaging terminal in a false mirror mode, e.g., using the videoconferencing terminals 10, 10′ of FIGS. 1 and 5. The method 54 operates a terminal that includes a state-switchable screen, e.g., the state-switchable screen 16, a video camera, e.g., the video camera 14, and a video projector, e.g., the video projector 18. In the terminal, the video camera is able to capture images through the state-switchable screen, and the video projector is able to project images on the state-switchable screen, i.e., projected images viewable by a viewer on the other side of the state-switchable screen. The viewer may be able to maintain direct eye-contact with himself or herself by watching projected images of himself or herself on the state-switchable screen.

The method 54 includes a step 56 of causing the screen to be regularly temporally interleaved between a diffusive state and a substantially transparent state. The video camera captures images of the viewer of the state-switchable screen when the screen is in the substantially transparent state. The video projector projects the same captured images on the state-switchable screen when the state-switchable screen is in the diffusive state. The video camera and projector are on a side of the screen opposite to a side of the viewer, e.g., the videoconference participant 12.

In the method 60, the step 56 of causing may produce a sequence of images of the viewer corresponding to images made by a non-inverting minor. That is, the projected images may not be left-right inverted so that imaged words are readable by the viewer. In other embodiments, said video images may be left-right inverted like ordinary minor reflections.

In the method 60, the step 56, the video projector may be located to not provide an image or virtual image thereof in a field-of-view of the viewer while the viewer makes eye-contact with himself or herself by watching himself or herself on the state-switchable screen.

In the method 60, the video camera may be configured to track movements of the head or gaze of the viewer so that the viewer perceives the maintenance of direct eye-contact with himself or herself.

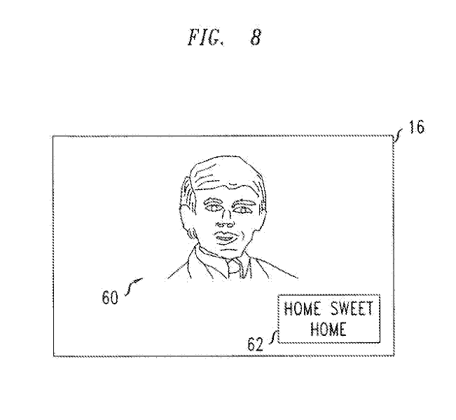

FIG. 8 illustrates a single video frame 60 of a false minor-mode image, e.g., made according to one example of the method 54 illustrated in FIG. 7. In the video frame 60, the local viewer maintains direct eye-contact with himself or herself due to the eye-contact maintenance feature of the videoconferencing terminals 10, 10′ of FIGS. 1 and 5. In addition, the example video frame 60 forms a false minor image in which objects are not minor-inverted, i.e., as shown for the imaged words 62. The absence of such minor-inversion may make the imaging terminal advantageous for minor-like applications outside of its usage for videoconferencing.

From the above disclosure, the figures, and the claims, other embodiments will be apparent to those of skill in the art.

What we claim is:

1. An apparatus, comprising:
a state-switchable screen;
a video camera; and
a video projector; and
wherein the video camera and projector are located on a side of the screen opposite to a side to be viewed by a videoconference participant; and
wherein the apparatus is configured to temporally interleave the screen between a substantially transparent state and a diffusive state, the video projector and any virtual image thereof being configured to be outside of a viewing field of the participant.

2. The apparatus of claim 1, further comprising:
a mirror configured to receive light of video images from the video projector and to direct said received light to the state-switchable screen.

3. The apparatus of claim 1, wherein the video camera is configured to not capture light for video image frames when the state-switchable screen is in the diffusive state.

4. The apparatus of claim 1, wherein the video projector is configured to not project light when the state-switchable screen is in the substantially transparent state.

5. The apparatus of claim 1, wherein the apparatus is configured to reorient or translate the video camera such that the videoconference participant looks into the camera in response to the head of the participant moving or in response to the eye gaze of the participant changing.

6. The apparatus of claim 1, further comprising an infrared tracking device, the terminal being configured to use data produced by the infrared tracking device to either locate a head of the participant or to determine a direction of the eye-gaze of the participant.

7. The apparatus of claim 1, wherein the apparatus is configured to operate in a feedback mode in which images captured by the video camera of the terminal are projected onto the state-switchable screen of the terminal.

8. The apparatus of claim 1, wherein the terminal further includes one or more lights directed to illuminate a face of the videoconference participant.

9. The apparatus of claim 1, wherein the terminal includes an AC voltage source and the state-switchable screen includes a liquid crystal layer, the AC voltage is connected to apply a voltage across the layer such that the screen is interleaved between the diffusive state and the substantially transparent state.

10. A method for operating a video conferencing terminal, the terminal including a state-switchable screen, a video camera, and a video projector, the method comprising:
causing the screen to temporally interleave between a diffusive state and a substantially transparent state, the video projector projecting images on the screen when the screen is in the diffusive state, the video camera capturing images through the screen when the screen is in the substantially transparent state, the video camera and projector being on a side of the screen opposite to a side thereof of a video conference participant watching the screen; and
wherein the terminal is configured such that the video projector and any image thereof are outside of a viewing field of the participant while the participant is directly looking at the video camera.

11. The method of claim 10, wherein the causing includes operating the video camera to not collect light for video images when the screen is in the diffusive state.

12. The method of claim 10, wherein the causing includes operating the video projector to not project light for video images when the screen is in the substantially transparent state.

13. The method of claim 10, wherein the video camera is configured to translate or re-orient such that the participant is able to look directly into the video camera in response to the head of the participant moving or to the eye gaze of the participant changing.

14. The method of claim 10 further comprising deflecting light of video images from the video projector to the state-switchable screen via a mirror, the mirror being located such that a virtual image of the video projector is outside of a field-of-view of the participant when the state-switchable screen in the substantially transparent state.

15. A method for operating a video terminal, the terminal including a state-switchable screen, a video camera, and a video projector, the method comprising:
causing the screen to temporally interleave between a diffusive state and a substantially transparent state, the video camera capturing images of a viewer of the screen when the screen is in the substantially transparent state, the video projector projecting the captured images on the screen when the screen is in the diffusive state, the video camera and projector being on a side of the screen opposite to a side thereof of the viewer.

16. The method of claim 15, wherein the causing produces a sequence of images of the viewer corresponding to images made by a non-inverting mirror.

17. The method of claim 15, wherein the causing enables the viewer to make eye-contact with himself or herself by watching the screen.

18. The method of claim 15, wherein the video projector is located to not provide an image thereof in a field of vision of the viewer while the viewer makes eye-contact with himself or herself by watching the screen.

19. The method of claim 15, wherein the video camera is configured to follow movements of the head of the viewer.

20. An apparatus, comprising:
a state-switchable screen;
a video camera; and
a video projector; and
wherein the video camera and projector are located on a side of the screen opposite to a side to be viewed by a viewer; and
wherein the apparatus is configured to temporally interleave the screen between a substantially transparent state and a diffusive state, the video projector being configured to project images captured by the video camera onto the screen such that the viewer is able to maintain direct eye-contact with himself or herself in said images.
